(19) United States
(12) Patent Application Publication
(10) Pub. No.: US 2012/0293697 A1
(43) Pub. Date: Nov. 22, 2012

(54) Image Sensor and Control Method for Image Sensor

(75) Inventors: Ping-Hung Yin, Grand Cayman (KY); Ching-Fong Chen, Grand Cayman (KY)

(73) Assignee: HIMAX IMAGING, INC., Grand Cayman (KY)

(21) Appl. No.: 13/108,381

(22) Filed: May 16, 2011

(51) Int. Cl. H04N 5/335; H01L 27/146

(52) U.S. Cl. 348/294; 250/208.1; 348/E05.091

(57) ABSTRACT

An image sensor including a plurality of first sensing pixels, a plurality of second sensing pixels, and a readout circuit is disclosed. The first sensing pixels are disposed within a sensitive region. The second sensing pixels are disposed within a non-sensitive region. The readout circuit repeatedly reads the output signals of the second sensing pixels to obtain an offset. The readout circuit processes the output signals of the first sensing pixels according to the offset.

### BACKGROUND OF THE INVENTION

1. Field of the Invention

The invention relates to an image sensor, and more particularly to an image sensor comprising a non-sensitive region.

2. Description of the Related Art

With technology development, functions and types of integrated circuit (IC) have increased. An IC comprises various electronic elements such as diodes, transistors, and operational amplifiers (Ops). Each electronic element may comprise a slight offset. If the electronic elements having offsets are integrated into an IC, the IC may comprise significant offset. If the IC serves as an image sensor, the image sensor may generate abnormal images signals due to the significant offset.

### BRIEF SUMMARY OF THE INVENTION

Image sensors are provided. An exemplary embodiment of an image sensor comprises a plurality of first sensing pixels, a plurality of second sensing pixels, and a readout circuit. The first sensing pixels are disposed within a sensitive region. The second sensing pixels are disposed within a non-sensitive region. The readout circuit repeatedly reads the output signals of the second sensing pixels to obtain an offset. The readout circuit processes the output signals of the first sensing pixels according to the offset.

A method for an image sensor is provided. The image sensor comprises a plurality of first sensing pixels and a plurality of second sensing pixels. The first sensing pixels are disposed within a sensitive region. The second sensing pixels are disposed within a non-sensitive region. An exemplary embodiment of a method for a portable device is described in the following. The output signals of the second sensing pixels are repeatedly read and processed to obtain an offset. The output signals of the first sensing pixels are processed according to the offset.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an image sensor of the invention;

FIG. 2 is a schematic diagram of another exemplary embodiment of an image sensor of the invention;

FIG. 3 is a schematic diagram of an exemplary embodiment of a sensing pixel of the invention;

FIG. 4 shows a timing control mechanism of sensing pixels in a calibration phase;

FIG. 5A is a schematic diagram of an exemplary embodiment of a control method of the invention; and

FIG. 5B and 6 are schematic diagrams of other exemplary embodiments of a control method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

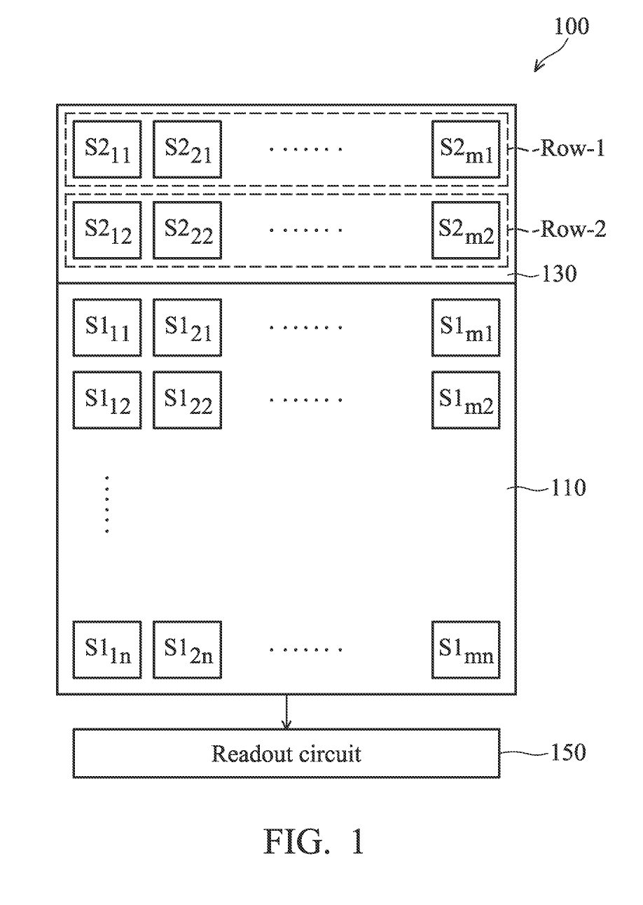

FIG. 1 is a schematic diagram of an exemplary embodiment of an image sensor of the invention. The image sensor 100 comprises an array of sensing pixels S1₁₁-S1ₘₙ and S2₁₁-S2ₘ₂ and a readout circuit 150. The invention does not limit the type of the image sensor 100. In one embodiment, the image sensor 100 may be a CMOS image sensor (CIS).

The sensing pixels S1₁₁-S1ₘₙ are disposed within a sensitive region 110. In this embodiment, the sensing pixels S1₁₁-S1ₘₙ are arranged in an array, but the disclosure is not limited thereto. In other embodiments, another method, such as a delta arrangement, is utilized to arrange the sensing pixels S1₁₁-S1ₘₙ.

The sensing pixels S2₁₁-S2ₘ₂ are disposed within a non-sensitive region 130. The invention does not limit the arranged form and the number of the sensing pixels S2₁₁-S2ₘ₂. In this embodiment, the sensing pixels S2₁₁-S2ₘ₂ are grouped into a first row Row-1 and a second row Row-2. In other embodiments, the sensing pixels S2₁₁-S2ₘ₂ are arranged into a single row. Additionally, the sensing pixels S2₁₁-S2ₘ₂ may be grouped into various groups.

In a calibration phase, the readout circuit 150 repeatedly reads the output signals of the sensing pixels S2₁₁-S2ₘ₂ to obtain an offset. The invention does not limit the sequence in which the output signals of the sensing pixels S2₁₁-S2ₘ₂ are read. In one embodiment, the processing module 150 sequentially reads the output signals of the first row Row-1 and the second row Row-2 and then immediately again reads (sequentially) the output signals of the first row Row-1 and the second row Row-2.

For example, the processing module 150 first reads and processes the output signals of the first row Row-1, then immediately reads and processes the output signals of the second row Row-2, then immediately again reads and processes the output signals of the first row Row-1 and then immediately again reads and processes the output signals of the second row Row-2.

The readout circuit 150 averages the reading and processing results. The averaged result serves as the offset. The offset comprises circuit offsets, pixel offsets or other operation offsets. Since the readout circuit 150 repeatedly reads the output signals of the sensing pixels S2₁₁-S2ₘ₂, the number of the sensing pixels disposed within the non-sensitive region 130 can be reduced.

Then in a readout phase after the calibration phase, the processing module 150 processes the output signals of the sensing pixels S1₁₁-S1ₘₙ according to the offset to obtain normal image signals.

In other embodiments, in the calibration phase, the readout circuit 150 waits for a preset period after obtaining the offset. After waiting for a preset period, the readout circuit 150 again reads and processes the output signals of the sensing pixels S2₁₁-S2ₘ₂ to obtain a dark signal corresponding to dark currents. The readout circuit 150 processes the output signals of the sensing pixels S1₁₁-S1ₘₙ according to the offset and the dark signal.

Taking the sensing pixels S2₁₁-S2ₘ₂ as an example, the readout circuit 150 reads and processes the output signals of the first row Row-1 and then reads and processes the output signals of the first row Row-2 after waiting for the preset period, for example, based on an exposure time of the image sensor 100. The readout circuit 150 obtains a dark signal according to the processing results. In one embodiment, the readout circuit 150 averages the processing results. The averaged result serves as a dark signal.

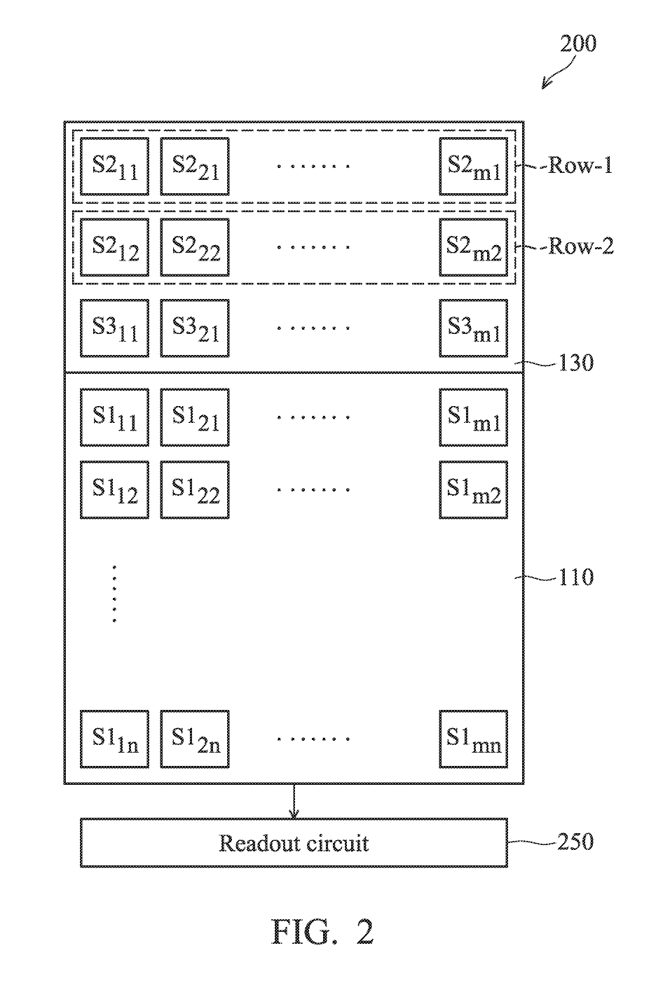

FIG. 2 is a schematic diagram of another exemplary embodiment of an image sensor of the invention. FIG. 2 is similar to FIG. 1 except for the addition of sensing pixels S3₁₁-S3ₘ₁. In this embodiment, the sensing pixels S3₁₁-S3ₘ₁ are disposed with the non-sensitive region 130.

In this embodiment, the readout circuit 250 is not required to wait for a preset period. The readout circuit 250 directly reads and processes the output signals of the sensing pixels S3₁₁-S3ₘ₁ to obtain a dark signal after obtaining the offset.

For example, the readout circuit 250 first reads and processes the output signals of the first row Row-1, then reads and processes the output signals of the second row Row-2, then again reads and processes the output signals of the first row Row-1 and then again reads and processes the output signals of the second row Row-2. The readout circuit 250 obtains an offset according to the processing results.

After obtaining the offset, the readout circuit 250 reads and processes the output signals of the sensing pixels S3₁₁-S3ₘ₁ to obtain a dark signal corresponding to the dark currents. The readout circuit 250 processes the output signals of the sensing pixels S1₁₁-S1ₘₙ according to the offset and the dark signal to obtain normal image signals.

In one embodiment, the readout circuit 250 deducts the offset and the dark signal from the output signals of the sensing pixels S1₁₁-S1ₘₙ. The deducted results serve as the normal image signals. In other embodiments, those skilled in the field utilize other methods to process the output signals of the sensing pixels S1₁₁-S1ₘₙ. While the pixel size getting smaller, the offset due to circuits is getting more significant than the dark signal. Thus, when the pixel size is below a certain threshold, only the offset is used for calibration.

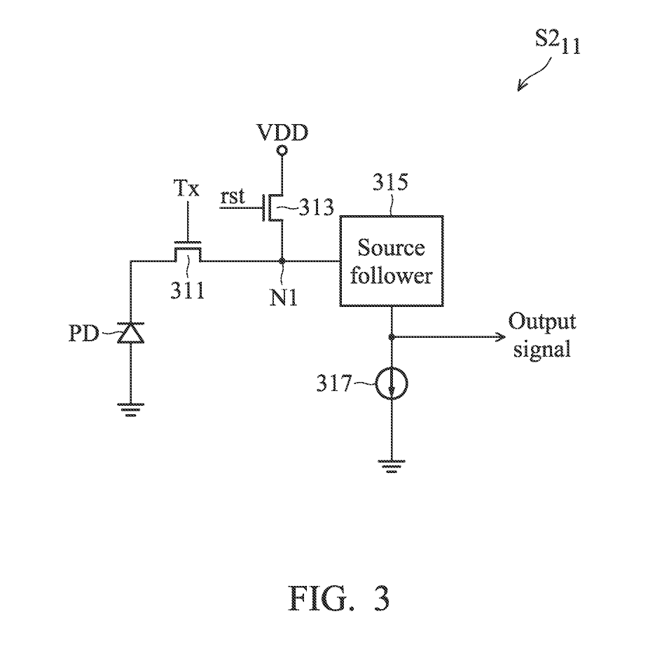

FIG. 3 is a schematic diagram of an exemplary embodiment of a sensing pixel of the image sensor 200. The sensing pixel, S2₁₁ for example, comprises a photodiode PD, a transfer switch 311, a reset switch 313, a floating diffusion N1 and a source follower 315. The source follower 315 outputs an output signal to the readout circuit 250 corresponding to the charges collected by the photodiode PD.

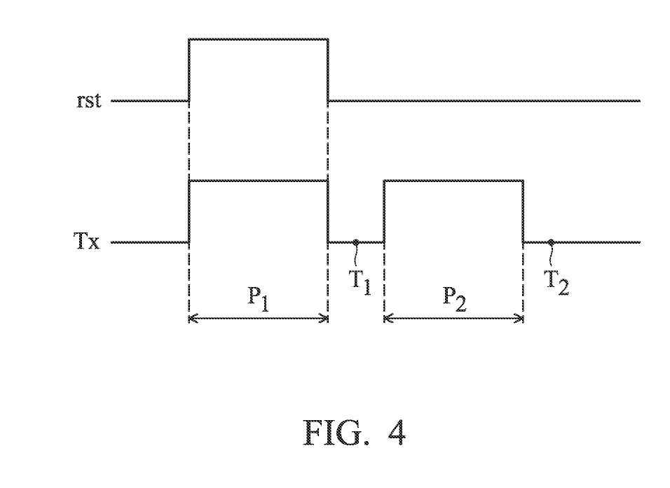

FIG. 4 shows a timing control mechanism of the sensing pixels in the calibration phase. During the period P₁, the reset signal rst and the transferring signal Tx are in a high level. Thus, the reset switch 313 and the transfer switch 311 are turned on to reset the photodiode PD.

At the timing point T₁, the readout circuit 250 reads and samples the level of the floating diffusion N1 via the source follower 315. During the period P₂, the reset signal rst is in a low level and the transferring signal Tx is in the high level. Since the reset switch 313 is turned off and the transfer switch 311 is turned on, the output signal of the photodiode PD is transferred to floating diffusion N1. At the timing point T₂, the readout circuit 250 again reads and samples the level of the floating diffusion N1 via the source follower 315. The readout circuit 250 obtains an offset according to the double sampling results. The obtained offset is caused by the circuitry of the sensing pixels and the readout circuit.

In one embodiment, the readout circuit 250 may comprise a differential amplifier to obtain the difference between the doubling sampling results. The readout circuit 250 serves the difference as an offset. The readout circuit 250 further comprises an average unit (not shown) to average the read-out results of all read-out circuits. The averaged result serves as the offset. The readout circuit 250 processes the output signals of the sensing pixels S1₁₁˜S1ₘₙ according to the offset. The processing methods for the output signals of the sensing pixels S1₁₁˜S1ₘₙ are well known to those skilled in the field, thus, descriptions thereof are omitted.

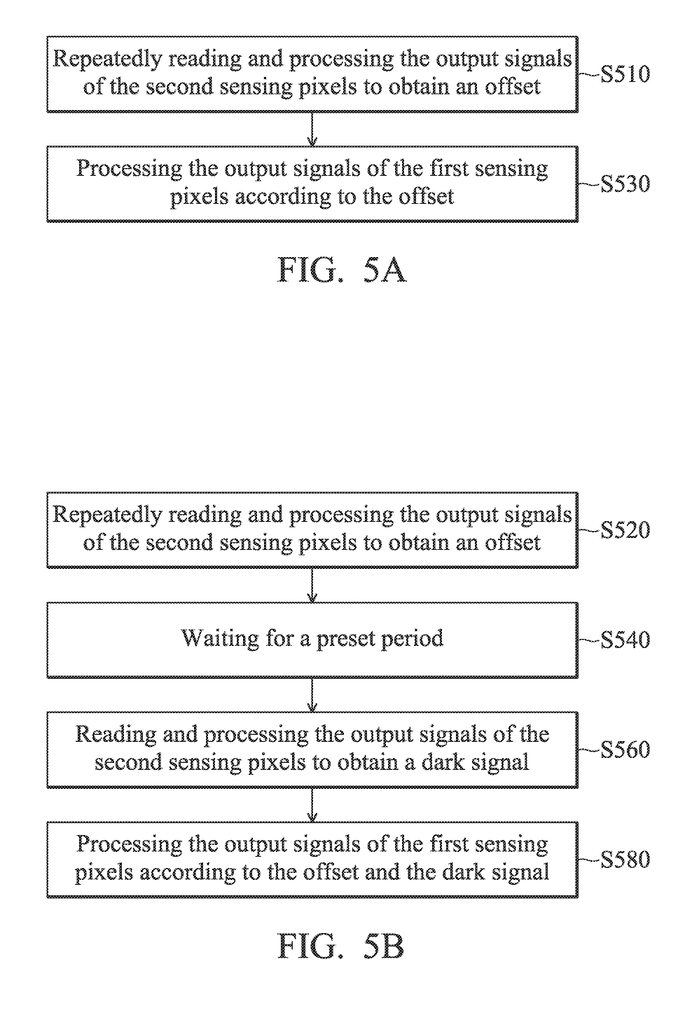

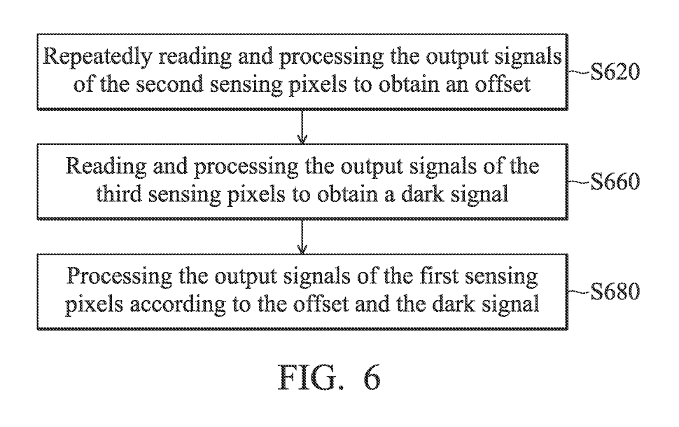

FIG. 5A is a schematic diagram of an exemplary embodiment of a control method of the invention. The control method is appropriate for an image sensor. The image sensor comprises a plurality of first sensing pixels and a plurality of second sensing pixels. The first sensing pixels are disposed within a sensitive region. The second sensing pixels are disposed within a non-sensitive region. In one embodiment, the image sensor is a CIS. In one embodiment, the non-sensitive region may have a light shielding layer that keeps the sensing pixels in the non-sensitive region from the light.

The output signals of the second sensing pixels are repeatedly read and processed to obtain an offset (step S510). The invention does not limit the reading and the processing methods from the output signals of the second sensing pixels. For example, the output signals of the second sensing pixels are sampled twice. The sampling results are utilized to obtain an offset. In one embodiment, a correlated double sampling (CDS) circuit is utilized to sample the output signals of the second sensing pixels.

In other embodiment, the second sensing pixels are grouped into a first row and a second row. The first and the second rows are repeatedly read and processed to obtain an offset.

For example, the output signals of the first row are first read and processed, then the output signals of the second row are read and processed, then the output signals of the first row are again read and processed, and the output signals of the second row are again read and processed.

In one embodiment, an offset is obtained according to the various processing results. For example, the various processing results are averaged to obtain an appropriate offset.

Next, the output signals of the first sensing pixels are processed according to the offset (step S530). The invention does not limit the processing method for the output signals of the first sensing pixels. In one embodiment, the offset obtained from step S510 is deducted from the output signals of the first sensing pixels, thus, normal image signals are obtained.

FIG. 5B is a schematic diagram of another exemplary embodiment of a control method of the invention. Step S520 of FIG. 5B is the same as step S510 of FIG. 5A, thus, the description of step S520 of FIG. 5B is omitted for brevity. After obtaining the offset (i.e. after step S520), an action is executed that waits for a preset period (step S540). In this embodiment, the preset period is an appropriate exposure time for the first sensing pixels. After waiting for the preset period, the first sensing pixels can sense sufficient light.

For example, if environment light is strong, the first sensing pixels only require a short exposure time to gain sufficient intensity. However, the first sensing pixels require a long exposure time to reach a sufficient intensity when environment light is weak. Thus, in one embodiment, the preset period of step S540 can be auto-adjusted according to the intensity of the environment light, or based on the exposure time of the first sensing pixels.

After step S540, the output signals of the second sensing pixels are again read and processed to obtain a dark signal corresponding to the dark currents (step S560). In step S560, the output signals of the second sensing pixels are read and processed once. After waiting for the preset period, the second sensing pixels sense sufficient light. Thus, a dark signal can be obtained according to the output signals of the second sensing pixels.

Assuming that the second sensing pixels are grouped into a first row and a second row. After step S540, the output signals of the first and the second rows are sequentially read and processed once to obtain a dark signal.

The offset obtained from step S520 and the dark signal obtained from step S560 are utilized to process the output signals of the first sensing pixels (step S580). Thus, normal image signals are obtained.

FIG. 6 is a schematic diagram of another exemplary embodiment of a control method of the invention. Steps S620 and S680 of FIG. 6 are the same as steps S520 and S580 of FIG. 5B, thus, descriptions of steps S620 and S680 of FIG. 6 are omitted for brevity.

After obtaining the offset, the output signals of the third sensing pixels are utilized to obtain a dark signal (step S660). In this embodiment, the third sensing pixels are disposed within the non-sensitive region. Since the third sensing pixels sense sufficient light during step S620, step S660 is directly executed after step S620.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image sensor, comprising:
a plurality of first sensing pixels disposed within a sensitive region;
a plurality of second sensing pixels disposed within a non-sensitive region; and
a readout circuit repeatedly reading the output signals of the second sensing pixels to obtain an offset, wherein the readout circuit processes the output signals of the first sensing pixels according to the offset.

2. The image sensor as claimed in claim 1, wherein after obtaining the offset, the readout circuit waits for a preset period and after waiting for the present period, the readout circuit again reads and processes the output signals of the second sensing pixels to obtain a dark signal, and the readout circuit processes the output signals of the first sensing pixels according to the offset and the dark signal.

3. The image sensor as claimed in claim 2, wherein the second sensing pixels are grouped into a first row and a second row, and
wherein the readout circuit first reads and processes the output signals of the first row, then reads and processes the output signals of the second row, then again reads and processes the output signals of the first row and then again reads and processes the output signals of the second row to obtain the offset.

4. The image sensor as claimed in claim 3, wherein the readout circuit averages the processing results and the averaged result serves as the offset.

5. The image sensor as claimed in claim 3, wherein after waiting for the preset period, the readout circuit again reads and processes the output signals of the first and the second rows to obtain the dark signal.

6. The image sensor as claimed in claim 1, further comprising:
a plurality of third sensing pixels disposed within the non-sensitive region, wherein the readout circuit obtains a dark signal according to the output signals of the third sensing pixels and processes the output signals of the first sensing pixels according to the offset and the dark signal.

7. The image sensor as claimed in claim 6, wherein the second sensing pixels are grouped into a first row and a second row, and
wherein the readout circuit first reads and processes the output signals of the first row, then reads and processes the output signals of the second row, then again reads and processes the output signals of the first row and then again reads and processes the output signals of the second row to obtain the offset.

8. The image sensor as claimed in claim 7, wherein after obtaining the offset, the readout circuit reads and processes the output signals of the third sensing pixels to obtain the dark signal.

9. A controlling method for an image sensor comprising a plurality of first sensing pixels disposed within a sensitive region and a plurality of second sensing pixels disposed within a non-sensitive region, comprising:
repeatedly reading and processing the output signals of the second sensing pixels to obtain an offset; and
processing the output signals of the first sensing pixels according to the offset.

10. The controlling method as claimed in claim 9, further comprising:
waiting for a preset period after obtaining the offset; and
again reading and processing the output signals of the second sensing pixels to obtain a dark signal, wherein the output signals of the first sensing

11. The controlling method as claimed in claim 10, wherein the second sensing pixels are grouped into a first row and a second row, and the step of repeatedly reading and processing the output signals of the second sensing pixels comprises:
reading and processing the output signals of the first row, then reading and processing the output signals of the second row;
again reading and processing the output signals of the first row and then again reading and processing the output signals of the second row; and
obtaining the offset according to the reading and processing results.

12. The controlling method as claimed in claim 11, wherein the reading and processing results are averaged and the averaged result serves as the offset.

13. The controlling method as claimed in claim 11, further comprising:
waiting for a preset period after obtaining the offset; and
sequentially reading and processing the output signals of the first and the second rows to obtain the dark signal.

14. The controlling method as claimed in claim 9, further comprising:
obtaining a dark signal according to the output signals of a plurality of third sensing pixels, wherein the third sensing pixels are disposed within the non-sensitive region.

15. The controlling method as claimed in claim 14, wherein the second sensing pixels are grouped into a first row and a second row, and the step of repeatedly reading and processing the output signals of the second sensing pixels comprises:
reading and processing the output signals of the first row, then reading and processing the output signals of the second row;
again reading and processing the output signals of the first row and then again reading and processing the output signals of the second row;
obtaining the offset according to the reading and processing results.

16. The controlling method as claimed in claim 15, further comprising:
reading and processing the output signals of the third sensing pixels to obtain the dark signal after obtaining the offset.

17. The controlling method as claimed in claim 9, wherein the step of repeatedly reading and processing the output signals of the second sensing pixels comprises:
sampling the output signals of the second sensing pixels; and
obtaining the offset according to the sampling results.

18. The controlling method as claimed in claim 17, wherein a correlated double sampling (CDS) circuit is utilized to sample the output signals of the second sensing pixels.
